(19) United States
(12) Patent Application Publication
(10) Pub. No.: US 2019/0249742 A1
(43) Pub. Date: Aug. 15, 2019

(54) Damping Valve For A Vibration Damper

(71) Applicant: ZF FRIEDRICHSHAFEN AG, Friedrichshafen (DE)

(72) Inventors: Aleksandar KNEZEVIC, Eitorf (DE); Jörg RÖSSELER, Ruppichteroth (DE)

(21) Appl. No.: 16/310,342

(22) PCT Filed: May 15, 2017
(86) PCT No.: PCT/EP2017/061550

§ 371 Date: Dec. 14, 2018

(30) Foreign Application Priority Data
Jun. 16, 2016 (DE) 10 2016 210 789.5

(51) Int. Cl. F16F 9/348; F16F 9/34; F16K 15/02; F16K 47/02

(52) U.S. Cl. CPC F16F 9/3485; F16K 47/023; F16K 15/023; F16F 9/3415

(57) ABSTRACT

A damping valve for a vibration damper includes a damping valve body with at least one passage, the outlet side of which is covered at least partially by at least one valve disk. When there is flow impinging via the passage, the at least one valve disk lifts up from a valve seat surface and a supporting disk, as a stop, limits the lift-off movement. The supporting disk is outfitted in direction of the valve disk with an elastomer support that is formed by a plurality of individual supporting elements. Between the at least one valve disk and the supporting disk there is a spacer disk moveably supported relative to the supporting disk that determines the lift-off movement characteristic of the valve disk.

### CROSS REFERENCE TO RELATED APPLICATIONS

This is a U.S. national stage of application No. PCT/EP2017/061550, filed on May 15, 2017. Priority is claimed on Germany Application No. DE102016210789.5, filed Jun. 16, 2016, the content of which is incorporated herein by reference.

### BACKGROUND OF THE INVENTION

### Field of the Invention

The invention is directed to damping valve.

### Description of the Prior Art

A damping valve for a vibration damper comprises a damping valve body with at least one passage, the outlet side of which is covered at least partially by at least one valve disk. When there is flow impinging on the valve side via the passage, the valve disk lifts up from a valve seat surface. Generally, to protect the valve disk against mechanical overloading, at least one supporting disk is used as a stop that limits the lift-off movement. In the simplest construction, the supporting disk is constructed as a simple, generally metal annular disk. In contrast, the valve disk is elastically deformable within limits or is axially movably supported against a spring. Regardless of the embodiment form, the effect whereby the valve disk strikes against the supporting disk occurs during sudden peak loads in damping operation. These impacts are audible.

One solution consists in using a plurality of valve disks in a layered arrangement. The layering brings about a supporting function within the stack of disks. A drawback is that an increase in the damping force characteristic occurs in valve disks that tend to be rigid.

A damping valve for a vibration damper having an elastomer support constructed as an elastomer ring, which opposes a stop movement of the valve disk against a supporting ring, is known from the generic DE 18 17 392 B2. With respect to the stop function, the elastomer ring acts like a sealing ring so that there can only be a radial flow of damping medium out of the damping valve.

### SUMMARY OF THE INVENTION

An object of one aspect of the present invention is to further develop the generic damping valve with a view to improving the flow-off behavior.

An elastomer support is formed by a plurality of individual supporting elements, and there is arranged between the at least one valve disk and the supporting disk a spacer disk that is moveably supported relative to the supporting disk and that determines the lift-off movement characteristic of the valve disk.

The supporting disk serves as a stop element that determines the maximum lift-off distance and possibly a tilting circle for the elastic valve disk. A damping valve can be adapted in a simple manner via the material thickness and/or the diameter.

In a further advantageous configuration, the spacer disk is supported at least on a portion of its lift path so as to be free of preloading with respect to the valve disk. The spacer disk is accordingly supported in a floating manner and does not exert any closing force on the valve disk.

Optionally, the at least one elastomer support can axially penetrate the spacer disk at least on a spring area of the elastomer support. The spacer disk may be provided with openings for this purpose.

For purposes of a simple assembly, the spacer disk centers itself at a flange of the supporting disk. The supporting disk serves, if necessary, as assembly support on which the spacer disk or spacer disks is or are placed.

To prevent an impact noise under any circumstances, the elastomer support has a stop area at which the spacer disk is supported after a defined lift path.

In case of a layered assembly of spacer disks having different outer diameters, it is advantageous when the spacer disk is configured to be elastic. The spacer disk then acts as a valve disk.

According to one aspect of the invention, the individual supporting elements are arranged on different pitch circles. This results in further options for adapting the damping valve, particularly when the spacer disk has a smaller diameter than the valve disk. In that case, elastomer supporting elements can be provided that preload only the valve disk and elastomer bodies that also influence the spacer disk. In this arrangement, the spacer disk need not have any openings for the elastomer support elements.

The individual supporting elements can have a varying axial distance from the valve disk for purposes of a progressive counterforce to the lift-off movement of the valve disk.

In order to convey the flow out of the damping valve in the lift region between the support on the valve disk and the contact at the supporting disk, the spacer disk can have at least one passage cross section.

### BRIEF DESCRIPTION OF THE DRAWINGS

The invention will be described in more detail referring to the following description of the figures.

The drawings show:

FIG. 1 is a sectional view of a damping valve; and

FIG. 2 is a top view of a spacer disk of the damping valve according to FIG. 1.

### DETAILED DESCRIPTION OF THE PRESENTLY PREFERRED EMBODIMENTS

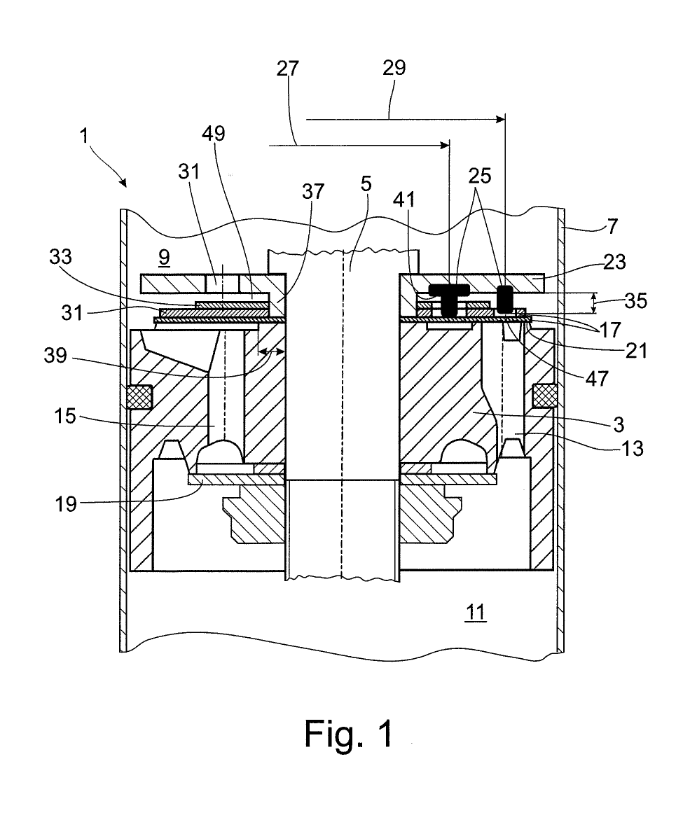

FIG. 1 shows a damping valve 1 for a vibration damper of any constructional type. The damping valve 1 comprises a damping valve body 3, which is fastened to a piston rod 5. The invention is not limited to an embodiment form of this type and can be used, e.g., in a bottom valve or also within the framework of an adjustable damping valve.

The damping valve body 3 divides a cylinder 7 of the vibration damper into a working chamber 9 on the piston rod side and a working chamber 11 remote of the piston rod. Both working chambers 9, 11 are filled with damping medium. Passages 13, 15, each for a flow direction, are formed on different pitch circles in the damping valve body 3. The configuration of the passages is to be considered exemplary only. An outlet side of the passages 13, 15 is at least partially covered by at least one valve disk 17, 19.

When there is an incident flow against the valve disk 17 proceeding from the working chamber 11 remote of the piston rod, the valve disk 17 lifts up from its valve seat surface 21. The lift-off movement is controlled or braked in a damping manner by a supporting disk 23 in combination with an elastomer support. The elastomer support is formed by a plurality of individual supporting elements 25.

The individual supporting elements 25 are preferably constructed as balls. Barrel-shaped constructions are also advantageous. Both constructional shapes can be mounted in a simple, position-independent manner.

The individual supporting elements 25 are arranged in the supporting disk 23 on different pitch circles 27, 29 with radii R₁ and R₂ and form a stop plane. Of course, other pitch circle diameters can also be used.

Between the at least one valve disk 17 and the supporting disk 23, there is arranged at least one spacer disk 31, 33 that is axially moveably supported relative to the supporting disk 23 and which determines the lift-off movement characteristic of the valve disk 17. The spacer disk 31, 33 is preferably supported at least on a portion of its lift path so as to be free of preloading with respect to the valve disk 17. As is shown in FIG. 1, the at least one elastomer support 25 can axially penetrate the spacer disk 31. 33 at least with a spring area 35 of the elastomer support. The spacer disk 31,33 is accordingly considered a flutter plate. In the simplest construction, the damping valve 1 comprises only one spacer disk 31. In the present case, two layered spacer disks 31, 33 are used. The outer individual supporting elements lie radially outside of a first smaller spacer disk 33. Consequently, the outer supporting elements influence the lift movement of the smaller spacer disk 33 only indirectly.

As is further disclosed by FIG. 1, each spacer disk 31, 33 centers itself at a flange 37 of the supporting disk 23. The valve disk 17 is tensioned on an inner contact surface 39 via the flange 37. The inner contact surface 39 need not necessarily lie in the plane of the valve seat surface 21. An additional preloading on the valve disk 17 can be achieved, for example, via a defined height offset when the seat surface 21 is formed so as to be raised in relation to the contact surface 39.

The individual supporting element can optionally have a stop area 41 at which the spacer disk 33 is supported proceeding from a defined lift path. In order to clarify the difference, the individual supporting element on pitch circle 27 has stop area 41 that has a diameter that is greater than openings in the spacer disk through which the individual supporting elements 25 extend. In comparison, the individual supporting elements on the larger pitch circle 29 are barrel-shaped with an extensively constant outer diameter.

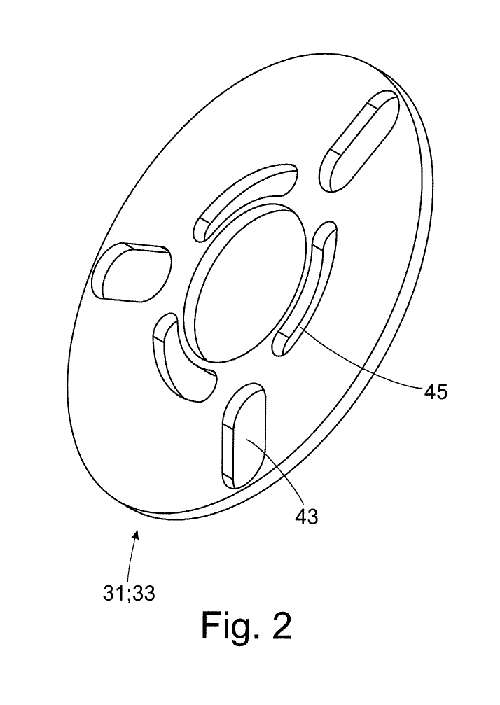

The spacer disk 31, 33 can also be configured to be elastic. Particularly in case of a layered arrangement of spacer disks 31, 33, an outer diameter of the smaller spacer disk 33 can form a tilting circle for the next spacer disk 31. As is shown in FIG. 2, the spacer disk 31, 33 can have at least one passage cross section 45 via which damping medium can flow out of the working chamber 11 remote of the piston rod into the working chamber 9 on the piston rod side.

When there is incident flow via passage 13, the damping medium impinges on the valve disk 17 that at least substantially closes the outlet orifice. The difference in pressure at valve disk 17 between passage 13 and working chamber 9 leads to a lift-off movement of the valve disk 17 from the valve seat surface 21. The individual supporting elements 25 oppose the lift-off movement on pitch circles 27, 29. As a result of the axial distance 47 of the individual supporting elements 25 on the larger pitch circle 29 from the valve disk 17, these individual supporting elements 25 first exert a counterforce when the valve disk 17 reaches these individual supporting elements in the opening process. Only a minimal damping force occurs. The spacer disks 31, 33 have no effect at the start of the lift-off process of the valve disk 17 from the valve seat surface because there is still a space 49 between spacer disk 33 and the supporting disk.

The damping force characteristic of the damping valve tends to change noticeably to the higher damping force only after the spacer disk 31 has at least indirectly contacted the supporting disk 23. The outer diameter of the spacer disk 33 then acts as a first tilting circle for the valve disk 17. If the spacer disk 31 is likewise constructed to be elastic, then the outer diameter of the smaller spacer disk 33 acts as tilting circle for valve disk 17 as well as for the larger spacer disk 31. Owing to the penetration of the spacer disks 31, 33 by the individual supporting elements 25, the individual supporting elements do not exert any closing force on the spacer disks 31, 33.

It is not until during the maximum lift movement of the two spacer disks that the latter contact the stop area 14 of the inner individual supporting elements 25. A damping force characteristic without knees generally results. A damping force characteristic without knees always results in a low piston rod acceleration and, therefore, low noise.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A damping valve for a vibration damper, comprising:
at least one valve disk configured to have a lift-up movement;
a valve seat surface;
a supporting disk;
a stop;
a damping valve body with at least one passage having an outlet side covered at least partially by the at least one valve disk;
an elastomer support that is formed by a plurality of individual supporting elements with which the supporting disk outfitted in direction of the at least one valve disk,
wherein, the at least one valve disk lifts up from the valve seat surface and the supporting disk when there is flow impinging via the at least one passage and the stop limits the lift-up movement; and
a spacer disk that is moveably supported relative to the supporting disk is arranged between the at least one valve disk and the supporting disk determines a lift-off movement characteristic of the at least one valve disk.

11. The damping valve according to claim 10, wherein the spacer disk is supported at least on a portion of its lift path to be free of preloading with respect to the at least one valve disk.

12. The damping valve according to claim 10, wherein an at least one individual supporting element axially penetrates the spacer disk at least on a spring area of an individual supporting element.

13. The damping valve according to claim 10, wherein the spacer disk centers at a flange of the supporting disk.

14. The damping valve according to claim 10, wherein an individual supporting element has a stop area at which the spacer disk is supported after a defined lift path.

15. The damping valve according to claim 10, wherein the spacer disk is elastic.

16. The damping valve according to claim 10, wherein an individual supporting elements are arranged on different pitch circles.

17. The damping valve according to claim 10, wherein an individual supporting elements have a varying axial distance from the at least one valve disk.

18. The damping valve according to claim 10, wherein the spacer disk has at least one passage cross section.
